(19) United States
(12) Patent Application Publication
(10) Pub. No.: US 2015/0043807 A1
(43) Pub. Date: Feb. 12, 2015

(54) DEPTH IMAGE COMPRESSION AND DECOMPRESSION UTILIZING DEPTH AND AMPLITUDE DATA

(71) Applicant: LSI Corporation, San Jose, CA (US)

(72) Inventors: Pavel A. Aliseychik, Moscow (RU); Alexander B. Kholodenko, Moscow (RU); Ivan L. Mazurenko, Moscow (RU); Aleksey A. Letunovskiy, Moscow (RU); Denis V. Parkhomenko, Moscow (RU)

(73) Assignee: LSI Corporation, San Jose, CA (US)

(21) Appl. No.: 14/186,513

(22) Filed: Feb. 21, 2014

(30) Foreign Application Priority Data
Aug. 12, 2013 (RU) 2013137742

(51) Int. Cl. G06T 9/00; G06K 9/00

(52) U.S. Cl. CPC G06T 9/00; G06K 9/00201
USPC 382/154

(57) ABSTRACT

In one embodiment, an image processing system comprises an image processor configured to obtain depth and amplitude data associated with a depth image, to identify a region of interest based on the depth and amplitude data, to separately compress the depth and amplitude data based on the identified region of interest to form respective compressed depth and amplitude portions, and to combine the separately compressed portions to provide a compressed depth image. The image processor may additionally or alternatively be configured to obtain a compressed depth image, to divide the compressed depth image into compressed depth and amplitude portions, and to separately decompress the compressed depth and amplitude portions to provide respective depth and amplitude data associated with a depth image. Other embodiments of the invention can be adapted for compressing or decompressing only depth data associated with a given depth image or sequence of depth images.

### CROSS-REFERENCE TO RELATED APPLICATION

This application claims foreign priority to Russia Patent Application No. 2013137742, filed on Aug. 12, 2013, the disclosure of which is incorporated herein by reference.

### FIELD

The field relates generally to image processing, and more particularly to image compression and decompression techniques.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications such as gesture recognition.

It is often desirable to compress images of the type described above. For example, compression is commonly used prior to transmission of an image over a communication medium in order to reduce the amount of bandwidth required to transmit that image. Also, compression may be used prior to storing an image in order to reduce the amount of storage capacity required by that image.

As is well known, compression techniques may be lossless or lossy. Examples of lossless compression techniques include Lempel-Ziv (LZ) compression algorithms such as LZ77 and LZ78, described in J. Ziv and A. Lempel, “A Universal Algorithm for Sequential Data Compression,” IEEE Transactions on Information Theory, 23(3), pp. 337-343, May 1977, and J. Ziv and A. Lempel, “Compression of Individual Sequences via Variable-Rate Coding,” IEEE Transactions on Information Theory, 24(5), pp. 530-536, September 1978, respectively. Lossy compression techniques include JPEG algorithms for individual images and MPEG algorithms for sequences of images.

Conventional image compression techniques such as JPEG and MPEG have been developed in the context of 2D image compression and are generally not optimized for use with depth images.

### SUMMARY

In one embodiment, an image processing system comprises an image processor configured to obtain depth and amplitude data associated with a depth image, to identify a region of interest based on the depth and amplitude data, to separately compress the depth and amplitude data based on the identified region of interest to form respective compressed depth and amplitude portions, and to combine the separately compressed portions to provide a compressed depth image.

The image processor may additionally or alternatively be configured to obtain a compressed depth image, to divide the compressed depth image into compressed depth and amplitude portions, and to separately decompress the compressed depth and amplitude portions to provide respective depth and amplitude data associated with a depth image.

Alternative embodiments of the invention can be adapted for compressing or decompressing only depth data associated with a given depth image or sequence of depth images, such that amplitude data is not utilized. Such embodiments can be used, for example, with image sensors that provide only depth data but not amplitude data.

An image processor in an illustrative embodiment may be configured to perform depth image compression, depth image decompression, or both depth image compression and decompression.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor configured to implement depth image compression and decompression utilizing depth and amplitude data in an illustrative embodiment.

FIG. 2 is a flow diagram of an illustrative embodiment of a depth image compression process implemented in the image processor of FIG. 1.

FIG. 3 is a flow diagram of an illustrative embodiment of a depth image decompression process implemented in the image processor of FIG. 1.

### DETAILED DESCRIPTION

Embodiments of the invention will be illustrated herein in conjunction with exemplary image processing systems that include image processors or other types of processing devices and implement techniques for compressing and decompressing of depth images. It should be understood, however, that embodiments of the invention are more generally applicable to any image processing system or associated device or technique that involves compression or decompression of one or more depth images.

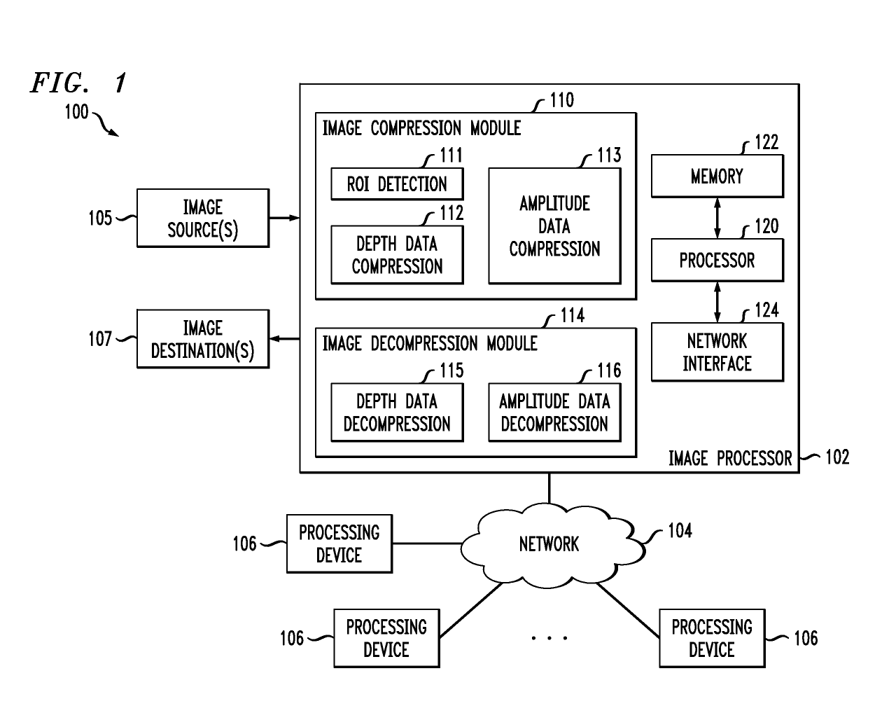

FIG. 1 shows an image processing system 100 in an embodiment of the invention. The image processing system 100 comprises an image processor 102 that receives images from one or more image sources 105 and provides processed images to one or more image destinations 107. The image processor 102 also communicates over a network 104 with a plurality of processing devices 106.

Although the image source(s) 105 and image destination(s) 107 are shown as being separate from the processing devices 106 in FIG. 1, at least a subset of such sources and destinations may be implemented at least in part utilizing one or more of the processing devices 106. Accordingly, images may be provided to the image processor 102 over network 104 for processing from one or more of the processing devices 106. Similarly, processed images may be delivered by the image processor 102 over network 104 to one or more of the processing devices 106. Such processing devices may therefore be viewed as examples of image sources or image destinations.

A given image source may comprise, for example, a 3D imager such as an SL camera or a ToF camera configured to generate depth images, or a 2D imager configured to generate grayscale images, color images, infrared images or other types of 2D images. A given SL camera, ToF camera or other type of depth imager may be configured to provide both a 3D image comprising depth data and a 2D image such as an intensity image comprising amplitude data. Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

Another example of an image destination is a transceiver of a processing device, for example, in the case of transmission of a compressed depth image from the image processor 102 to another device or system.

Also, although the image source(s) 105 and image destination(s) 107 are shown as being separate from the image processor 102 in FIG. 1, the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to include functionality for depth and amplitude data based compression and decompression of images received from a given image source. The resulting compressed or decompressed images may then be subject to additional processing operations in the image processor 102 or in one of the processing devices 106. Such additional processing operations may include, for example, storage, transmission or image processing of a compressed or decompressed image.

The images processed in the image processor 102 are assumed to comprise depth images generated by a depth imager such as an SL camera or a ToF camera. In some embodiments, the image processor 102 may be at least partially integrated with such a depth imager on a common processing device.

Each depth image is assumed to comprise depth data associated with corresponding amplitude data. For example, the amplitude data may be in the form of a grayscale image or other type of intensity image that is generated by the same SL camera or ToF camera that generates the depth image. An intensity image of this type may be considered part of the depth image itself, or may be implemented as a separate intensity image that corresponds to or is otherwise associated with the depth image. Other types and arrangements of depth images comprising depth data and having associated amplitude data may be received and processed in other embodiments.

The image processor 102 as illustrated in FIG. 1 includes an image compression module 110 comprising a region of interest (ROI) detection module 111, a depth data compression module 112 and an amplitude data compression module 113. These modules are configured in the present embodiment to obtain depth and amplitude data associated with a depth image, to identify a region of interest based on the depth and amplitude data, to separately compress the depth and amplitude data based on the identified region of interest to form respective compressed depth and amplitude portions, and to combine the separately compressed portions to provide a compressed depth image.

The image processor 102 further includes an image decompression module 114 comprising a depth data decompression module 115 and an amplitude data decompression module 116. These modules are configured in the present embodiment to obtain a compressed depth image, to divide the compressed depth image into compressed depth and amplitude portions, and to separately decompress the compressed depth and amplitude portions to provide respective depth and amplitude data associated with a depth image.

The particular number and arrangement of modules shown in image processor 102 in the FIG. 1 embodiment can be varied in other embodiments. For example, in other embodiments two or more of these modules may be combined into a lesser number of modules, or the disclosed image compression or image decompression functionality may be distributed across a greater number of modules. An otherwise conventional image processing integrated circuit or other type of image processing circuitry suitably modified to perform processing operations as disclosed herein may be used to implement at least a portion of one or more of the modules 110, 111, 112, 113, 114, 115 and 116 of image processor 102.

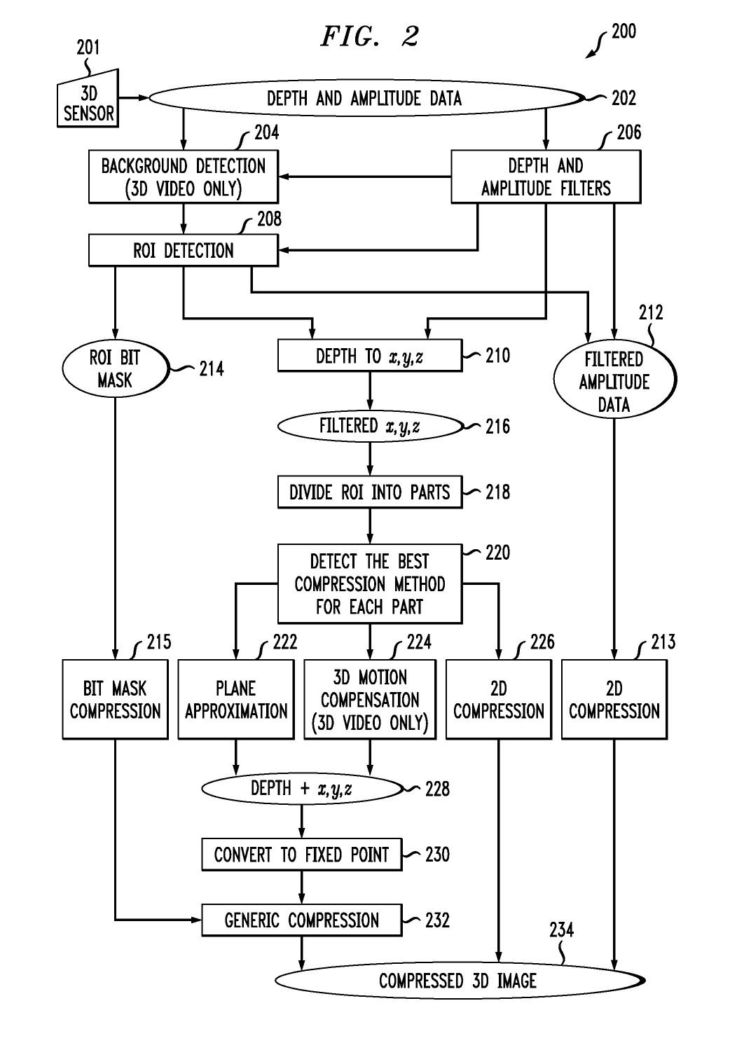

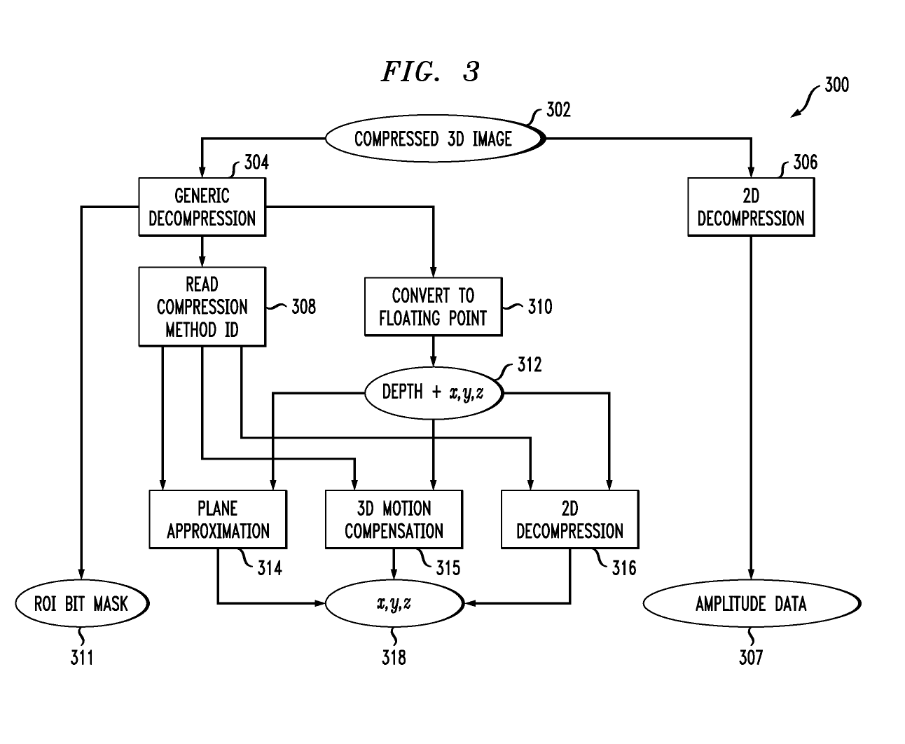

The operation of the image compression module 110 and the image decompression module 114 of image processor 102 will be described in greater detail below in conjunction with the flow diagrams of FIGS. 2 and 3, respectively. These flow diagrams illustrate exemplary processes for depth image compression and decompression utilizing both depth and amplitude data in the image processor 102. Other embodiments may perform depth image compression and decompression without the use of amplitude data.

A compressed depth image generated by image compression module 110 of the image processor 102 may be provided to one or more of the processing devices 106 or image destinations 107 over the network 104, for storage, transmission or further image processing. For example, one or more such processing devices may comprise respective image processors configured to perform additional processing operations such as feature extraction, gesture recognition and automatic object tracking using depth images that are received in compressed form and then decompressed prior to the additional processing. Alternatively, such operations may be performed in the image processor 102.

A compressed depth image received by the image processor 102 from an image source 105 or processing device 106 is decompressed by image decompression module 114. The resulting decompressed depth image may then be subject to additional processing operations such as feature extraction, gesture recognition and automatic object tracking in the image processor 102. Again, these operations may be performed in image processor 102 or in another processing device.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. By way of example, a computer or mobile phone may be configured to incorporate the image processor 102 and possibly a given image source. The image source(s) 105 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations, including operations relating to depth image compression and decompression.

The image processor 102 in this embodiment also illustratively comprises a network interface 124 that supports communication over network 104, although it should be understood that an image processor in other embodiments of the invention need not include such a network interface. Accordingly, network connectivity provided via an interface such as network interface 124 should not be viewed as a requirement of an image processor configured to perform depth image compression or decompression as disclosed herein.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as portions of modules 110, 111, 112, 113, 114, 115 and 116. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to applications other than gesture recognition, such as machine vision systems in robotics and other industrial applications.

Referring now to FIG. 2, an exemplary process 200 implemented primarily by image compression module 110 of image processor 102 is shown. Portions of the process 200 may be implemented at least in part utilizing software executing on image processing hardware of the image processor 102. For example, operations associated with one or more of processing blocks 204, 206, 208, 210, 213, 215, 218, 220, 222, 224, 226, 230 and 232 may be implemented at least in part in the form of software associated with image compression module 110.

It is assumed in this embodiment that an input image received in the image processor 102 from an image source 105 comprises a depth map or other depth image from a depth imager such as an SL camera or a ToF camera. The depth imager is illustratively shown in FIG. 2 as comprising a 3D sensor 201.

The depth image is further assumed to correspond to one of a sequence of images in a 3D video signal supplied by the 3D sensor 201 to the image processor, and to comprise a rectangular array of picture elements, also referred to as pixels. Such images in the context of the 3D video signal are also referred to as frames. Accordingly, a given 3D video signal as the term is used herein should be understood to encompass a sequence of 3D frames, and is also referred to as 3D video.

A given depth image is assumed to be captured at or otherwise associated with a particular frame time tₙ. For example, the depth image may denote a particular 3D video frame captured at time tₙ by the 3D sensor 201. Many depth imagers use a variable or floating frame rate, in which generally tₙ−tₙ₋₁≠tₙ₋₁−tₙ₋₂, where tᵢ denotes the capture time of the i-th frame. A given pixel of the depth image may be more particularly denoted herein by its row and column coordinates within that image.

In some embodiments, the input depth image is supplied directly to the image processor 102 from the 3D sensor 201. However, such an image may be subject to one or more preprocessing operations, in the image processor 102 or elsewhere in the system, before being subject to the processing operations illustrated in FIG. 2.

As mentioned above, the input depth image in the present embodiment is assumed to include depth data that is associated with corresponding amplitude data. The corresponding amplitude data may be integrated with the depth data into a single image or may be otherwise associated with the depth data. For example, the amplitude data may be provided in a separate grayscale image or other type of intensity image that is generated by the same 3D sensor 201 that generates the depth image.

Accordingly, references herein to depth and amplitude data associated with a depth image are intended to be broadly construed so as to encompass, by way of example, arrangements in which amplitude data is incorporated into the depth image itself or arrangements in which amplitude data is provided within a separate intensity image that is associated with the depth image. In arrangements of the latter type, the intensity image providing the amplitude data is captured at substantially the same time as the depth image, possibly using the same depth imager used to capture the depth image.

Each such depth image or intensity image is assumed to have the same dimensions or size, namely, a width W specifying the number of columns of pixels in the image and a height H specifying the number of rows of pixels in the image.

In the process 200, 3D sensor 201 generates a sequence of depth images having depth data and associated amplitude data as previously described. The 3D sensor 201 in the present embodiment is therefore assumed to provide depth and amplitude data 202 associated with one or more depth images. In other embodiments, as indicated previously, the amplitude data may be provided by a separate sensor or imager than that used to generate the depth data.

The depth and amplitude data may be provided, for example, in the form of respective matrices of integers or floating point numbers, with each matrix entry corresponding to a different pixel of the depth image. The depth data in such an arrangement indicates for each pixel the distance between the 3D sensor 201 and a corresponding point in an imaged scene and the amplitude data indicates for each pixel the amount of light received by that pixel. The present embodiment of the invention utilizes both depth and amplitude data to provide improved compression of the depth image.

The depth and amplitude data for a given depth image are assumed to be stored together in memory 122 or another storage device of system 100 in the form of a single data file, although other storage arrangements may be used.

The process 200 as illustrated may be viewed as one example of an arrangement that involves obtaining depth and amplitude data associated with a depth image, identifying a region of interest based on the depth and amplitude data, separately compressing the depth and amplitude data based on the identified region of interest to form respective compressed depth and amplitude portions, and combining the separately compressed portions to provide a compressed depth image.

The process 200 may be used to process sequences of depth images in the form of a 3D video signal or may be used to process individual depth images.

In the case of compressing 3D video, which as indicated above comprises a sequence of 3D frames, a background detection operation is applied in block 204 to the depth and amplitude data 202. This operation illustratively involves, for example, detecting background information in the depth and amplitude data 202, and eliminating at least a portion of the background information from consideration in identifying a region of interest. For example, depth image pixels having depth and amplitude values that do not change significantly over a designated time period can be considered background pixels and eliminated as described above.

Elimination of background pixels may involve, for example, removing those pixels by replacing them with other predetermined values, such as zero or one values or a designated average pixel value. However, it should be noted that terms such as “eliminate” and “eliminating” as used herein in the context of a given pixel should not be construed as being limited to replacement, modification or other type of removal of that pixel, and are instead intended to be more broadly construed so as to encompass, for example, association of a mask with the image where the mask indicates whether or not particular pixels are to be used in subsequent processing operations.

The process 200 also applies depth and amplitude filters in block 206 to the respective depth and amplitude portions of data 202. Examples of filters that may be applied to one or both of the depth and amplitude data include low-pass linear filters to remove high frequency noise, high-pass linear filters for noise analysis, edge detection and motion tracking, bilateral filters for edge-preserving and noise-reducing smoothing, morphological filters such as dilate, erode, open and close, median filters to remove “salt and pepper” noise, and dequantization filters to remove quantization artifacts.

Different sets of one or more of these and other filters may be used for the respective depth and amplitude data. Also, the type of filters used may be adjusted depending upon the desired compression quality, which may be lossless or near-lossless compression, or lossy compression.

The outputs of the blocks 204 and 206 are applied as inputs to region of interest detection block 208. A region of interest is identified in block 208 based on the filtered depth and amplitude data from block 206, possibly after eliminating from consideration background information detected in block 206. This may involve the use of separate depth and amplitude thresholds for the respective depth and amplitude data. Although detection of a single region of interest is assumed in this embodiment, other embodiments may involve detection of multiple regions of interest within a depth image.

As a more particular example, the region of interest detection block 208 can use separate depth and amplitude thresholds for defining the region of interest as a list of horizontal segments, by storing for each row of the image a pair of coordinates [aᵢ,bᵢ] denoting the pixels in that row that bound the region of interest. In other words, the pair of coordinates for a given row identify the respective first and last coordinates of that row that belong to the region of interest. By way of example, if the width of the image in columns is less than or equal to 256, one byte of information is needed to store each a, and b, coordinate.

Outputs of blocks 206 and 208 provide filtered depth data that is converted to x, y and z coordinates in block 210. The x, y and z coordinates are also referred to as Cartesian coordinates. At least a portion of the depth data and corresponding x, y and z coordinates can be stored in memory 122 or another storage device of system 100 as integers with different precisions.

The depth to x, y, z conversion block 210 can be implemented, for example, using the following C++ code:

Point3D dist2point(int ix, int iy, float r)
{
double dx=2.0 * (ix−(W−1.0)/2.0) * tan(angle_x/2.0) / W;
double dy=2.0 * (iy−(H−1.0)/2.0) * tan(angle_y/2.0) / H;
double z = r / sqrt(1.0 + dx*dx + dy*dy);
return Point3D(float(z*dx),float(z*dy),float(z));
}

where ix and iy denote the respective column and row of a particular pixel in the depth data matrix, r is the depth value of this pixel, and angle_x and angle_y are sensor-dependent parameters. This arrangement therefore implements a sensor-dependent transformation of depth values to respective points in x, y, z space, such that the resulting points are substantially independent of the particular sensor type. Other embodiments can use other conversion techniques to convert the depth values.

Outputs of blocks 206 and 208 also provide filtered amplitude data 212 that is subject to 2D compression in block 213. The resulting exemplary compressed amplitude portion will subsequently be combined with a separately compressed depth portion in forming a compressed depth image.

The region of interest identified in block 208 is used to generate a region of interest bit mask 214. The bit mask 214 is separately compressed in bit mask compression block 215. The resulting compressed bit mask will also subsequently be combined into the compressed depth image with the separately compressed depth and amplitude portions as described in more detail below.

The bit mask 214 is an example of what is more generally referred to herein as a “mask” and in the present embodiment is assumed to comprise a single bit for each pixel of the depth image with the binary value of that bit indicating whether or not the corresponding pixel is part of the region of interest. Alternative masks include, for example, masks that have multiple-bit values for each pixel of the depth image, as well as other arrangements that provide information sufficient to identify portions of the depth image that are associated with one or more regions of interest.

Block 216 provides filtered x, y and z coordinates. These filtered coordinates may be generated at least in part using filters of the type previously described in conjunction with block 206.

The filtered x, y and z coordinates from block 216 are applied as inputs to block 218 in which the region of interest is divided into parts. The parts are further processed in block 220 in order to detect the best compression method to utilize for each of the parts. This embodiment more particularly assumes that the image compression module 110 has multiple compression algorithms available for selection based on the particular characteristics of the different parts of the region of interest. Each part is then compressed in accordance with its corresponding selected compression algorithm.

Division of the region of interest into parts in block 218 may involve separating the region of interest into multiple pixel blocks of a designated size, such as, for example, 8×8 blocks of pixels.

The available compression algorithms in this embodiment include a plane approximation algorithm in block 222, a 3D motion compensation algorithm suitable for use with 3D video in block 224 and a 2D compression algorithm in block 226.

Blocks 222 and 224 provide respective plane approximation and rigid body movement approximation for parts of the region of interest. The rigid body movement approximation relates to movement within a sequence of 3D frames of a 3D video signal and may incorporate motion compensation.

In the plane approximation block 222, a given part of the region of interest is approximated by a plane, and is represented by the three coordinates of that plane as well as the distance of each pixel in the given part to the plane. If these distances are small, as will generally be the case if the surface of the region of interest in the given part is close to the plane approximation, this transformation reduces the number of bits needed for representing the pixels of the given part.

In the 3D motion compensation block 224, differences between specified parts of the region of interest in successive 3D frames of the 3D video signal are represented as rigid body motion. For example, motion parameters such as three Euler angles and three shift coordinates may be used to represent the rigid body motion. Residual values for each pixel are also part of the representation.

In the 2D compression block 226, a given part of the region of interest is viewed as a grayscale image and compressed using a standard 2D compression algorithm.

These compression algorithms are well known to those skilled in the art and are therefore not described in further detail herein. Other sets of compression algorithms can be provided for selective use in compressing parts of a region of interest in other embodiments.

For example, as an additional compression step, an x, y, z to depth transformation can be performed, although such a step is not illustrated in the figure. This can be implemented using a sensor-independent calculation such as:

r=\sqrt{(x²+y²+z²)}

It should be noted that this transformation is not an exact inverse to the exemplary depth to x, y, z transformation implemented in block 210, as the latter transformation illustratively utilizes sensor-dependent parameters.

Depth data and associated x, y and z coordinates 228 representing compressed parts of the region of interest provided by blocks 222 and 224 are converted to fixed point notation in block 230 and then applied with compressed bit mask 215 to a generic compression block 232. The outputs of the blocks 213, 226 and 232 are then combined to provide the compressed 3D image 234 at the output of the process 200.

Although not explicitly shown in the figure, it is assumed that each part of the region of interest has an associated identifier that indicates the particular compression method that was applied to that part. These identifiers are utilized in the decompression process that will be described below in conjunction with FIG. 3.

The conversion to fixed point notation in block 230 utilizes a specified number of bits providing a desired recoverable image quality. The generic compression utilized in block 232 is typically a lossless compression. The previous compression operations implemented in blocks 215, 222 and 224 ensure that the information to be compressed in the generic compression block 232 is relatively small and therefore requires a relatively small number of bits even for lossless compression.

A compressed depth image generated by image compression module 110 in the manner illustrated in FIG. 2 can be decompressed using process 300 shown in FIG. 3. The decompression process 300 is implemented primarily by image decompression module 114 of image processor 102. Portions of the process 300 may be implemented at least in part utilizing software executing on image processing hardware of the image processor 102. For example, operations associated with one or more of processing blocks 304, 306, 308, 310, 314, 315 and 316 may be implemented at least in part in the form of software associated with image decompression module 114.

The process 300 as illustrated may be viewed as one example of an arrangement that involves obtaining a compressed depth image, dividing the compressed depth image into compressed depth and amplitude portions, and separately decompressing the compressed depth and amplitude portions to provide respective depth and amplitude data associated with a depth image.

The process 300 may be used to process sequences of compressed depth images in the form of a compressed 3D video signal or may be used to process individual compressed depth images.

A given compressed 3D image 302 is divided into a compressed depth portion that is applied to generic decompression block 304 and a compressed amplitude portion that is applied to 2D decompression block 306. The 2D decompression block 306 recovers amplitude data 307 associated with the corresponding decompressed depth image.

After the generic decompression of the compressed depth portion in block 304, compression method identifiers are read in block 308 and fixed point depth data is converted to floating point in block 310. The region of interest bit mask portion of the output of the generic decompression block 304 is used to recover a region of interest bit mask 311.

The conversion in block 310 results in depth data and corresponding x, y, z coordinates 312. Although not specifically illustrated, transformed x, y, z coordinates can be calculated from the depth data using a sensor-independent transformation. This may also involve addition of residual values, if such residual values are available.

The depth data and corresponding x, y, z coordinates 312 are applied to processing blocks 314, 315 and 316 which implement decompression algorithms for respective plane approximation, 3D motion compensation and 2D decompression.

Block 308 identifies the particular compression method that was used for each of the parts of the region of interest. This information is provided to the blocks 314, 315 and 316 such that the appropriate decompression algorithm can be applied to each part. Outputs of the blocks 314, 315 and 316 are used to recover the x, y, z coordinates 318 of the decompressed depth image.

In the present embodiment, depth data outside of the region of interest is not restored from the compressed depth image. Instead, the region of interest bit mask 311 may be used to notify subsequent processing applications that the depth data outside of this image is invalid. Alternatively, the corresponding values in one or both of the depth and amplitude matrices used in subsequent processing may be replaced with designated values, such as zero values. This will allow subsequent processing applications based on respective depth or amplitude thresholds to effectively ignore values outside the region of interest. As indicated previously, alternative embodiments can identify multiple regions of interest in the compression process, or can provide different handling of data outside one or more regions of interest.

At least portions of the processes of FIGS. 2 and 3 can be pipelined in a straightforward manner. For example, subsets of the processing blocks can be executed at least in part in parallel with one another, thereby reducing the overall latency of the process for a given input image, and facilitating implementation of the described techniques in real-time image processing applications. Also, vector processing in firmware can be used to accelerate at least portions of one or more of the processing blocks.

It is also to be appreciated that the particular processing blocks used in the embodiment of FIGS. 2 and 3 are exemplary only, and other embodiments can utilize different types and arrangements of image processing operations. For example, the particular techniques used to detect the background information and the region of interest, to separate the region of interest into parts, to select an appropriate compression algorithm for each part, and to combine different compressed depth and amplitude portions into a compressed image, can be varied in other embodiments. Also, as noted above, one or more processing blocks indicated as being executed serially in the figure can be performed at least in part in parallel with one or more other processing blocks in other embodiments.

Moreover, other embodiments of the invention can be adapted for compressing only depth data associated with a given depth image or sequence of depth images. For example, with reference to the processes of FIGS. 2 and 3, portions of the processes associated with amplitude data processing in blocks 202, 206, 212, 213 and 234 of FIG. 2 and blocks 302, 306 and 307 in FIG. 3 can be eliminated in embodiments in which a 3D image sensor outputs only depth data and not amplitude data. Accordingly, the processing of amplitude data in FIGS. 2 and 3 may be viewed as optional in other embodiments.

Embodiments of the invention such as those illustrated in FIGS. 2 and 3 provide particularly efficient techniques for compressing and decompressing depth images by using both depth and amplitude data associated with a given depth image. For example, these techniques can provide significantly better compression ratios than conventional depth image compression techniques. Also, the disclosed techniques can support multiple compression levels including both near-lossless compression and lossy compression, thereby permitting resulting image quality to be adjusted based on application requirements. Furthermore, the image compression can be implemented in a manner that is independent of the particular sensor used, such that image decompression can be performed without any need for knowledge of sensor-dependent parameters.

It should again be emphasized that the embodiments of the invention as described herein are intended to be illustrative only. For example, other embodiments of the invention can be implemented utilizing a wide variety of different types and arrangements of image processing circuitry, modules and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
obtaining depth and amplitude data associated with a depth image;
identifying a region of interest based on the depth and amplitude data;
separately compressing the depth and amplitude data based on the identified region of interest to form respective compressed depth and amplitude portions; and
combining the separately compressed portions to provide a compressed depth image;
wherein said obtaining, identifying, separately compressing and combining are implemented in at least one processing device comprising a processor coupled to a memory.

2. The method of claim 1 further comprising applying depth and amplitude filters to the respective depth and amplitude data and wherein identifying a region of interest based on the depth and amplitude data comprises identifying the region of interest based on filtered depth and amplitude data.

3. The method of claim 1 wherein identifying a region of interest based on the depth and amplitude data comprises identifying the region of interest using separate depth and amplitude thresholds for the respective depth and amplitude data.

4. The method of claim 1 further comprising storing the depth and amplitude data together in a single data file.

5. The method of claim 1 further comprising converting at least a portion of the depth data to x, y and z coordinates.

6. The method of claim 5 further comprising storing at least a portion of the depth data and corresponding x, y and z coordinates as integers with different precisions.

7. The method of claim 1 further comprising:
detecting background information in the depth and amplitude data; and
eliminating at least a portion of the background information from consideration in identifying the region of interest.

8. The method of claim 1 wherein separately compressing the depth and amplitude data based on the identified region of interest to form respective compressed depth and amplitude portions further comprises:
separating depth data corresponding to the region of interest into parts;
selecting one of a plurality of available compression algorithms for each of the parts; and
compressing each part in accordance with its corresponding selected compression algorithm.

9. The method of claim 8 wherein the plurality of available compression algorithms include at least a plane approximation algorithm, a 3D motion compensation algorithm and a 2D compression algorithm.

10. The method of claim 1 further comprising:
generating a mask based on the identified region of interest;
separately compressing the mask; and
combining the compressed mask into the compressed depth image.

11. The method of claim 10 wherein combining the compressed mask into the compressed depth image further comprises:
applying a first compression algorithm to the compressed mask and at least a portion of the depth data;
applying a second compression algorithm to the amplitude data; and
combining outputs of the first and second compression algorithms to form the compressed depth image.

12. A computer-readable storage medium having computer program code embodied therein, wherein the computer program code when executed in the processing device causes the processing device to perform the method of claim 1.

13. A method comprising:
obtaining depth data associated with a depth image;
identifying a region of interest based on the depth data;
separating depth data corresponding to the region of interest into parts;
selecting one of a plurality of available compression algorithms for each of the parts; and
compressing each part in accordance with its corresponding selected compression algorithm to provide a compressed depth image;
wherein said obtaining, identifying, separating, selecting and compressing are implemented in at least one processing device comprising a processor coupled to a memory.

14. An apparatus comprising:
at least one processing device comprising a processor coupled to a memory;
wherein said at least one processing device is configured to obtain depth and amplitude data associated with a depth image, to identify a region of interest based on the depth and amplitude data, to separately compress the depth and amplitude data based on the identified region of interest to form respective compressed depth and amplitude portions, and to combine the separately compressed portions to provide a compressed depth image.

15. An integrated circuit comprising the apparatus of claim 14.

16. An image processing system comprising the apparatus of claim 14.

17. A method comprising:
obtaining a compressed depth image;
dividing the compressed depth image into compressed depth and amplitude portions; and
separately decompressing the compressed depth and amplitude portions to provide respective depth and amplitude data associated with a depth image;
wherein said obtaining, dividing and separately decompressing are implemented in at least one processing device comprising a processor coupled to a memory.

18. A computer-readable storage medium having computer program code embodied therein, wherein the computer program code when executed in the processing device causes the processing device to perform the method of claim 17.

19. An apparatus comprising:
at least one processing device comprising a processor coupled to a memory;
wherein said at least one processing device is configured to obtain a compressed depth image, to divide the compressed depth image into compressed depth and amplitude portions, and to separately decompress the compressed depth and amplitude portions to provide respective depth and amplitude data associated with a depth image.

20. An integrated circuit comprising the apparatus of claim 19.

21. An image processing system comprising the apparatus of claim 19.
